(19) United States
(12) Patent Application Publication
(10) Pub. No.: US 2006/0215299 A1
(43) Pub. Date: Sep. 28, 2006

(54) Shock-resistant magnetic storage medium for a portable electronic device

(76) Inventors: Ju-Song Kao, Chung-Ho City (TW); Ming-Shen Kao, Tu-Cheng City (TW); Chia-Te Hou, Tao-Yuan Hsien (TW); Fu-Hsiung Lin, Pan-Chiao City (TW); Ming-Chen Chou, Hsin-Chuang City (TW); Shih-Kuang Huang, Hua-Lian Hsien (TW); Li-Uen Lu, Chung-Ho City (TW); Ching-Teng Liu, Keelung City (TW); Ching-Wen Li, Miao-Li Hsien (TW)

Correspondence Address: CHRISTIE, PARKER & HALE, LLP, PO BOX 7068, PASADENA, CA, 91109-7068, US

(21) Appl. No.: 11/087,185

(22) Filed: Mar. 22, 2005

(51) Int. Cl. G11B 19/02; G11B 21/02

(52) U.S. Cl. 360/69; 360/75

(57) ABSTRACT

A shock-resistant magnetic storage medium includes a circuit protection module coupled between a power converter and a magnetic disk assembly. The circuit protection module includes an acceleration sensor for generating output signals that indicate a falling state of the magnetic disk assembly, a switch operable so as to make or break a circuit connection between the power converter and the magnetic disk assembly, and a processor for controlling the switch to break the circuit connection between the power converter and the magnetic disk assembly based on the output signals from the acceleration sensor so as to interrupt supply of electric power to the magnetic disk assembly when the magnetic disk assembly is dropped.

### BACKGROUND OF THE INVENTION

1. Field of the Invention

The invention relates to a data storage medium, more particularly to a shock-resistant magnetic storage medium that is not easily damaged when dropped. This invention also relates to a portable electronic device that incorporates a shock-resistant magnetic storage medium.

2. Description of the Related Art

Portable electronic devices, such as MP3 players, still and moving cameras, and smart mobile phones, are very popular nowadays. Currently, some of these devices have a built-in mini hard disk that permits storage of a large amount of digital data, such as audio and/or image files. For example, the ipod Mini® by Apple Computers incorporates a mini hard disk with a 4 GB capacity that can be used to store up to 1000 audio files.

Referring to FIG. 1, a conventional hard disk 9 generally includes a base 91, at least one magnetic disk 92 on the base 91, a spindle motor 93, a voice coil motor 94, and at least one read/write (R/W) arm set 95 including an arm 951 and a magnetic head 952. If there is more than one magnetic disk 92, each magnetic disk 92 is associated with a set of the magnetic heads 952, which correspond to upper and lower magnetic recording surfaces of the disk 92, respectively. The arm 951 moves each magnetic head 952 for writing or reading data to or from the corresponding magnetic recording surface of the disk 92. In addition, the hard disk 9 is further provided with a parking area (not shown) beside the magnetic disk 92. Each magnetic head 952 can be parked at the parking area to avoid scratching the magnetic disk 92.

Data is recorded on the magnetic recording surface of the magnetic disk 92 by dividing files into sector data. The arm 951 is driven by the voice coil motor 94 to move back and forth on sectors of the magnetic recording surface of the magnetic disk 92. Since operation of the magnetic head 952 is based on electromagnetic sensing principles, and since the magnetic head 952 is designed to float with respect to the magnetic disk 92, there is no need for the magnetic head 952 to contact the corresponding surface of the magnetic disk 92, and a large amount of data can be quickly written to or read from the magnetic disk 92. Hence, it is necessary to lay the magnetic disk 92 flat relative to the base 91 so that an appropriate spacing can be maintained between its magnetic recording surface and the corresponding magnetic head 952 in order to prevent damage and ensure proper writing and reading of data.

Since the hard disk 9 is a mechanical device, regardless of high speed or idle operation, physical damage can occur as a result of an external applied force or a fall. Therefore, the mini hard disks installed in portable electronic devices have stringent anti-shock requirements. Currently, there are two techniques widely employed in the industry to enhance the anti-shock characteristics of mini hard disks in portable electronic devices. The first technique involves the use of a buffer material capable of absorbing shock. The second technique involves interruption of read/write activity based on detected speed so as to reduce the possibility of damage due to impact to a minimum.

However, the aforesaid protection techniques suffer from the following drawbacks:

1. In the first technique, a layer of the buffer material is applied to the outer periphery of the hard disk in order to cushion impact. To improve protection when dropped from greater heights, the thickness of the buffer material layer must be increased, which results in a corresponding increase in the overall dimensions of the hard disk. For example, when the buffer material on the outer periphery of the hard disk is rubber, a thickness of 5 mm is only sufficient to cushion an impact force of about 240 G.

2. In the second technique, a G-sensor is employed to detect the fall of a portable electronic device. Hence, read/write activity of a magnetic head can be terminated before the portable electronic device reaches the ground In the case of the hard disk, upon detection by a controller (not shown) of a device falling state, a command will be issued, such as through the 8-bit address bus of the ATAPI in the IDE interface, for stopping movement of the R/W arm set 95 and the magnetic disk 92 to prevent damage to the magnetic disk 92. However, the time period from fall detection to issuing the stop command in the second technique is relative long.

Generally, in a state of use, a mobile phone is held against the user's ear, whereas a MP3 player is placed in a pocket of the user, and an earphone is connected to the MP3 player and is plugged to the user's ear. In both cases, the mobile phone or the MP3 player is usually disposed at a height of 1 to 1.5 meters from the ground. Hence, storage media for portable electronic devices must have adequate shock protection when dropped from such heights in order to meet practical user requirements.

### SUMMARY OF THE INVENTION

Therefore, the main object of the present invention is to provide a shock-resistant magnetic storage medium that is not easily damaged when dropped and that can overcome the aforesaid drawbacks of the prior art.

Another object of the present invention is to provide a portable electronic device that incorporates the shock-resistant magnetic storage medium of this invention.

According to one aspect of the invention, a shock-resistant magnetic storage medium comprises: a power converter adapted for converting electric power from a power source to result in a power signal; a magnetic disk assembly including a magnetic recording unit for recording data, and a read/write mechanism for reading data from and writing data to the magnetic recording unit; and a circuit protection module. The circuit protection module includes:

an acceleration sensor for generating output signals that indicate a falling state of the magnetic disk assembly;

a switch coupled between the power converter and the magnetic disk assembly and operable so as to make or break a circuit connection between the power converter and the magnetic disk assembly; and

a processor coupled electrically to the acceleration sensor, the switch, the power converter and the magnetic disk assembly, and responsible for controlling operations of the magnetic disk assembly.

The processor further controls the switch to break the circuit connection between the power converter and the magnetic disk assembly based on the output signals from the acceleration sensor so as to interrupt supply of electric power to the magnetic disk assembly when the magnetic disk assembly is dropped.

According to another aspect of the present invention, a portable electronic device comprises a housing, and the aforesaid shock-resistant magnetic storage medium installed in the housing.

### BRIEF DESCRIPTION OF THE DRAWINGS

Other features and advantages of the present invention will be come apparent in the following detailed description of the preferred embodiment with reference to the accompanying drawings, of which:

FIG. 1 is a schematic diagram of a conventional hard disk for a portable electronic device;

FIG. 2 is a schematic block diagram of the preferred embodiment of a shock-resistant magnetic storage medium for a portable electronic device according to the present invention;

FIG. 3 is a schematic diagram to illustrate the shock-resistant magnetic storage medium of the preferred embodiment forming an angle (Θ) with respect to a Z-axis when in a falling state; and

FIG. 4 illustrates a portable electronic device that incorporates the shock-resistant magnetic storage medium of the preferred embodiment when dropped at a height (H₁) from the ground.

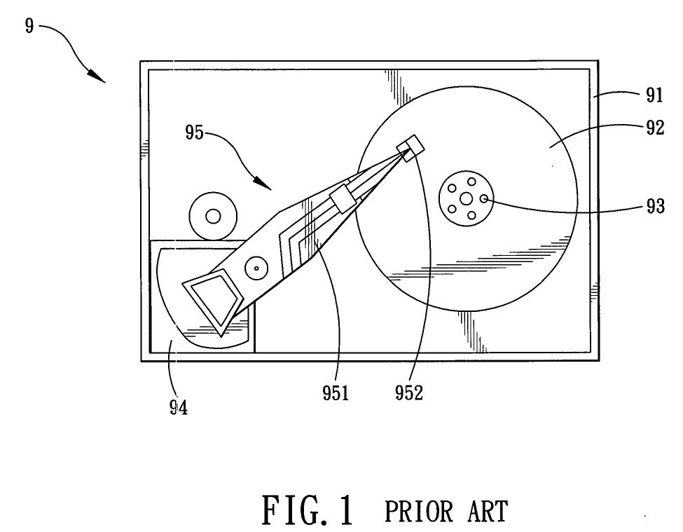

### DETAILED DESCRIPTION OF THE PREFERRED EMBODIMENT

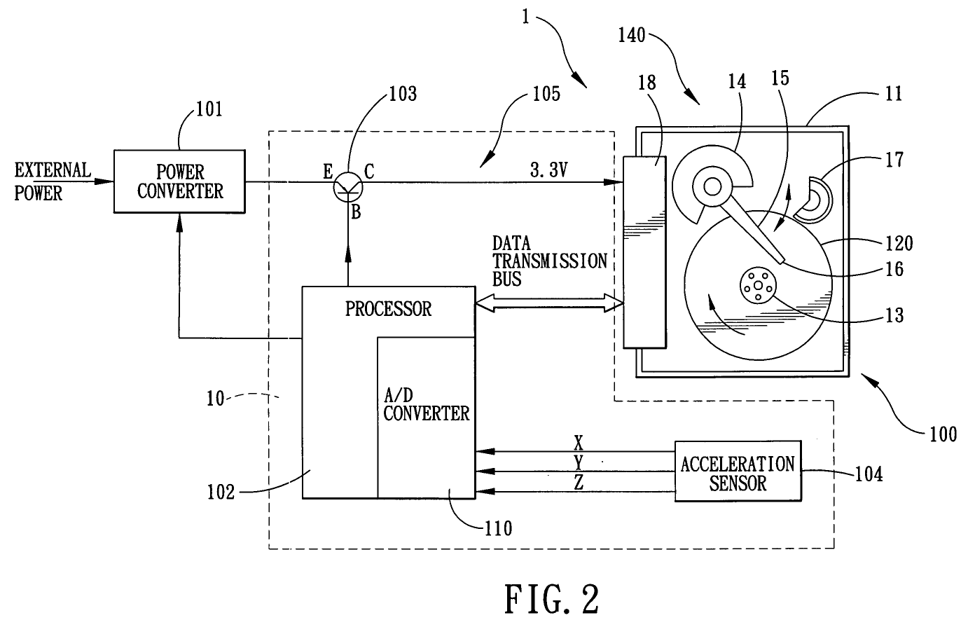

Referring to FIGS. 2 and 4, the preferred embodiment of a shock-resistant magnetic storage medium 1 according to the present invention is adapted for use in a portable electronic device 3 (see FIG. 4), such as a portable computer, a MP3 player, a mobile phone, etc., to enable the user of the portable electronic device 3 to store audio and/or image files, as well as data files.

The shock-resistant magnetic storage medium 1 of this invention is to be installed inside a housing 31 of the portable electronic device 3, and includes a magnetic disk assembly 100, a power converter 101, and a circuit protection module 10 coupled between the magnetic disk assembly 100 and the power converter 101. Preferably, in order to achieve optimum protection, the shock-resistant magnetic storage medium 1 further includes a protective layer (not shown) made from a buffer material, such as rubber, and applied to the outer periphery of the magnetic disk assembly 100. The thickness of the protective layer ranges from 1.5 to 2 mm.

The power converter 101 is used to convert electric power from a power source so as to result in a power signal suitable for application to the various components of the magnetic storage medium 1. For example, the power converter 101 can be configured to convert a 5-volt power signal from an adapter or a 3.7-volt power signal from an internal battery to obtain a 3.3-volt stable DC signal for supply to the magnetic disk assembly 100 and a processor 102 of the circuit protection module 10.

The magnetic disk assembly 100 includes a magnetic recording unit 120 for recording data, and a read/write (R/W) mechanism 140 for reading data from and writing data to the magnetic recording unit 120. The shock-resistant design of this invention is suitable for application to storage media which record data in a magnetic format and which require protection against vibrations and fall. Examples of such storage media include hard disks, optical read/write devices (such as DVD and/or CD R/W devices), etc.

In this embodiment, the magnetic disk assembly 100 is a hard disk, and further includes a base 11 and a spindle motor 13 for driving the magnetic recording unit 120. The R/W mechanism 140 includes a voice coil motor 14, an arm 15, a magnetic head 16 provided on one end of the arm 15, a parking seat 17, and a transmission interface 18 provided on the base 11. Since the basic components and operating principle of the hard disk are known in the art and are not pertinent to the claimed invention, they will not be described further herein for the sake of brevity.

The circuit protection module 10, which is coupled between the magnetic disk assembly 100 and the power converter 101, includes a processor 102, a switch 103, and an acceleration sensor 104.

The processor 102 is coupled electrically to the power converter 101, the transmission interface 18 of the magnetic disk assembly 100, and the acceleration sensor 104. Aside from being able to control power-supplying activity of the power converter 101, the processor 102 is also able to control various operations of the magnetic disk assembly 100. For example, the processor 102 is able to control speed of the spindle motor 13 through a data transmission bus, operation of a controller (not shown) of the voice coil motor 14, data read/write (R/W) activities for the magnetic recording unit 120, etc. Moreover, the processor 102 is responsible for controlling switching activity of the switch 103 in a manner to be described hereinafter.

The switch 103 is coupled electrically to the magnetic disk assembly 100, the power converter 101 and the processor 102. Preferably, the switch 103 is a transistor, such as a PNP or FET transistor. In this embodiment, the switch 103 is a PNP transistor that is controlled by the processor 102 so as to make or break a circuit connection 105 between the power converter 101 and the magnetic disk assembly 100.

In this embodiment, the base (B) of the transistor is coupled electrically to a GPIO control pin of the processor 102. The collector (C) of the transistor is coupled electrically to the magnetic disk assembly 100. The emitter (E) of the transistor is coupled electrically to the power converter 101 so as to receive an output voltage of the latter. Under normal operating conditions, the processor 102 controls the transistor through the GPIO control pin thereof to make the circuit connection 105 between the power converter 101 and the magnetic disk assembly 100, i.e., electric power is supplied to the magnetic disk assembly 100 through the collector (C) of the transistor. When it is determined by the processor 102 that power supply to the magnetic disk assembly 100 is to be interrupted, the processor 102 controls the transistor through the GPIO control pin thereof to break the circuit connection 105 between the power controller 101 and the magnetic disk assembly 100, thereby forcibly interrupting the supply of electric power to the magnetic disk assembly 100.

In this embodiment, the acceleration sensor 104 is a known gravitational acceleration sensor that generates output signals in response to detected changes in rotary angles about three axes, i.e., X, Y and Z axes. The acceleration sensor 104 is disposed at a central portion of a circuit board (not shown) of the circuit protection module 10. The circuit board has the processor 102 and the switch 103 mounted thereon. The acceleration sensor 104 generates the output signals that indicate detected changes in rotary angles about the three axes, i.e., the X, Y and Z axes, when the magnetic disk assembly 100 is in a falling state. The output signals of the acceleration sensor 104 are provided to the processor 102, and an analog-to-digital (A/D) converter 110 of the processor 102 converts the output signals into digital signals for subsequent comparison to threshold values set beforehand in the processor 102. Based on the comparison results, the processor 102 is able to determine whether or not the magnetic disk assembly 100 is in a falling state.

In the conventional protection scheme, upon detection that the gravitational acceleration change in any of the three axes has exceeded the corresponding threshold value, a shock detect signal will be generated so as to enable execution of emergency measures, such as interruption of any read/write activity for the magnetic recording unit by the R/W mechanism. However, such a protection scheme is only applicable for instances of small-scale vibrations. At heights of 1 to 1.5 meters from the ground, since electric power is still being supplied, damage to the magnetic storage medium cannot be avoided.

In the preferred embodiment, since the magnetic disk assembly 100 rotates as the magnetic storage medium 1 falls to the ground, the processor 102 receives the output signals from the acceleration sensor 104 and determines whether the digital signals obtained by the A/D converter 110 exceed their corresponding threshold values. Upon detection that any of the digital signals has exceeded the corresponding threshold value, the processor 102 controls the switch 103 to break the circuit connection 105 between the power converter 101 and the magnetic disk assembly 100. At this time, since the controller (not shown) of the voice coil motor 14 no longer receives electric power from the transmission interface 18, the voice coil motor 14 is de-energized, and the arm 15 and the magnetic head 16 on the arm 15 will be moved automatically for parking at the parking seat 17 so as to avoid damage to the magnetic recording unit 120 and the magnetic head 16. In other words, possible damage to the magnetic recording unit 120 can be reduced to a minimum when the magnetic storage medium 1 falls to the ground.

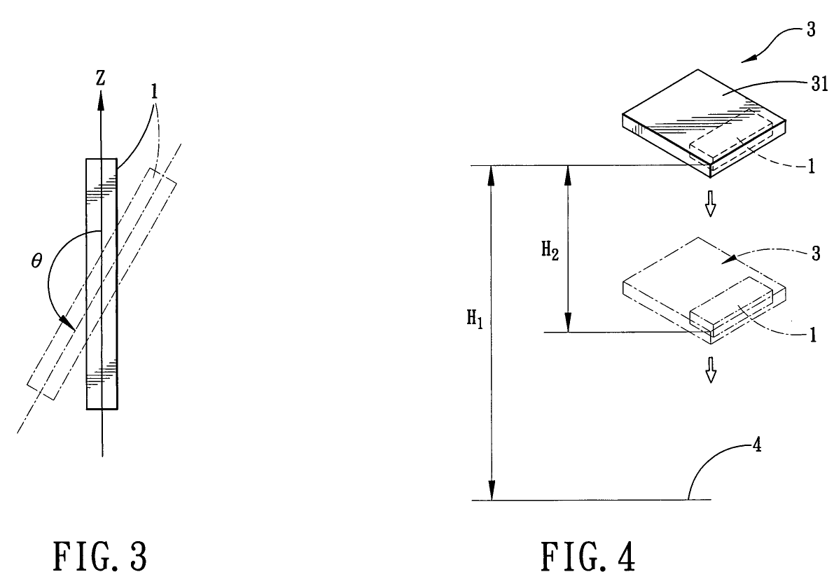

With reference to FIGS. 2 and 3, the magnetic storage medium 1 is shown to rotate at an angle (Θ) with respect to the Z-axis. The magnitude of the output signal from the acceleration sensor 104 changes with the angle (Θ). In the preferred embodiment, when repeated sampling (n=5) of the digital signal corresponding to the Z-axis angle component indicates that the corresponding threshold value has been exceeded repeatedly, the processor 102 can make the decision to break the circuit connection 105 through the switch 103 accordingly. Referring once again to FIGS. 2 and 4, when the magnetic storage medium 1 is installed in the housing 31 of the portable electronic device 3, and the portable electronic device 3 is dropped from a height (H₁), the time needed to reach the ground is (S₁). In the present invention, a decision to change the magnetic storage medium 1 from an operating state to a non-operating state can be made within a time (S₂) much shorter than the time (S₁), that is, the portable electronic device 3 has dropped a small fraction (H₂) of the height (H₁).

Based on actual experiments, when the height (H₁), which is an initial distance of the portable electronic device 3 that incorporates the magnetic storage medium 1 from the ground 4, is 1 meter, the response time (S2) required for the processor 102 to decide whether it is necessary to change the magnetic storage medium 1 from the operating state to the non-operating state is about 200 ms, that is, the portable electronic device 3 has fallen a distance (H₂) of about 30 cm. Upon interruption of the supply of electric power to the magnetic disk assembly 100, the arm 15 and the magnetic head 16 on the arm 15 of the magnetic disk assembly 100 are restored to the parking seat 17 to avoid damage to the magnetic recording unit 120. Shock-resistance when the magnetic storage medium 1 is at the non-operating state can reach as high as 2000G.

The following are some of the advantages of the shock-resistant magnetic storage medium 1 of the present invention over the prior art:

1. In the present invention, the supply of electric power to the magnetic disk assembly 100 and the controller of the voice coil motor 14 is forcibly interrupted upon detection through the acceleration sensor 104 that the rotation angle about any of the three axes has exceeded the corresponding threshold value set in the system beforehand. Since the magnetic storage medium 1 is in the non-operating state upon power interruption, shock resistance can reach as high as 2000G. In contrast, shock resistance is only about 200G when the magnetic storage medium is in an operating state. Moreover, in the prior art, about 300-400 ms is required to pull back the arm and the magnetic head through issuance of an appropriate command via the 8-bit address bus of the ATAPI in the IDE interface. In the present invention, only 20-50 ms is required to interrupt supply of electric power and restore the arm 15 and the magnetic head 16 to the parked state.

2. When the processor 102 controls the switch 103 to interrupt the supply of electric power to the magnetic disk assembly 100, power to the controller of the voice coil motor 14 will be interrupted. As a result, the voice coil motor 14 will be de-energized, and the arm 15 and the magnetic head 16 on the arm 15 of the R/W mechanism 140 will be forced to move to a parked position beside the magnetic recording unit 120 to reduce the possibility of damage to the magnetic recording unit 120 and the magnetic head 16 to a minimum when the magnetic storage medium 1 is dropped.

3. In view of the reasons set forth hereinabove in items 1 and 2, the thickness of the protective layer on the outer periphery of the magnetic disk assembly 100 can be reduced to 1.5 mm, thereby minimizing the corresponding increase in the overall dimensions of the portable electronic device 3 to meet practical requirements of consumers.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A shock-resistant magnetic storage medium comprising:
a power converter adapted for converting electric power from a power source to result in a power signal;
a magnetic disk assembly including a magnetic recording unit for recording data, and a read/write mechanism for reading data from and writing data to said magnetic recording unit; and
a circuit protection module including
an acceleration sensor for generating output signals that indicate a falling state of said magnetic disk assembly,
a switch coupled between said power converter and said magnetic disk assembly and operable so as to make or break a circuit connection between said power converter and said magnetic disk assembly, and
a processor coupled electrically to said acceleration sensor, said switch, said power converter and said magnetic disk assembly, and responsible for controlling operations of said magnetic disk assembly,
said processor further controlling said switch to break the circuit connection between said power converter and said magnetic disk assembly based on the output signals from said acceleration sensor so as to interrupt supply of electric power to said magnetic disk assembly when said magnetic disk assembly is dropped.

2. The shock-resistant magnetic storage medium as claimed in claim 1, wherein said acceleration sensor is a gravitational acceleration sensor that generates the output signals in response to detected changes in rotary angles about three axes.

3. The shock-resistant magnetic storage medium as claimed in claim 2, wherein said processor converts the output signals from said acceleration sensor into digital signals, compares the digital signals with preset threshold values, and determines whether the supply of electric power to said magnetic disk assembly is to be interrupted based on comparison results obtained by said processor.

4. The shock-resistant magnetic storage medium as claimed in claim 1, wherein said processor compares the output signals from said acceleration sensor with preset threshold values, and controls said switch based on comparison results obtained by said processor.

5. The shock-resistant magnetic storage medium as claimed in claim 1, wherein said switch is a transistor.

6. The shock-resistant magnetic storage medium as claimed in claim 5, wherein said transistor is one of a FET and PNP transistor.

7. The shock-resistant magnetic storage medium as claimed in claim 1, wherein said magnetic disk assembly further includes a transmission interface, said read/write mechanism restoring to a parked state beside said magnetic recording unit to avoid damaging said magnetic recording unit when said read/write mechanism ceases to receive electric power through said transmission interface upon breaking of the circuit connection between said power converter and said magnetic disk assembly by said switch.

8. A portable electronic device comprising:
a housing; and
a magnetic storage medium installed in said housing and including
a power converter adapted for converting electric power from a power source to result in a power signal,
a magnetic disk assembly including a magnetic recording unit for recording data, and a read/write mechanism for reading data from and writing data to said magnetic recording-unit, and
a circuit protection module including
an acceleration sensor for generating output signals that indicate a falling state of said housing,
a switch coupled between said power converter and said magnetic disk assembly and operable so as to make or break a circuit connection between said power converter and said magnetic disk assembly, and
a processor coupled electrically to said acceleration sensor, said switch, said power converter and said magnetic disk assembly, and responsible for controlling operations of said magnetic disk assembly,
said processor further controlling said switch to break the circuit connection between said power converter and said magnetic disk assembly based on the output signals from said acceleration sensor so as to interrupt supply of electric power to said magnetic disk assembly when said housing is dropped.
